(19) United States
(12) Patent Application Publication
(10) Pub. No.: US 2005/0047486 A1
(43) Pub. Date: Mar. 3, 2005

(54) SPREAD SPECTRUM COMMUNICATION SYSTEM RECEIVING DEVICE

(75) Inventors: Mikio SAKAUE, Tokyo (JP); Hidenori TOMISHIMA, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: GCOMM CORPORATION, Tokyo (JP)

(21) Appl. No.: 10/710,126

(22) Filed: Jun. 21, 2004

(30) Foreign Application Priority Data
Sep. 1, 2003 (JP) 2003-347564

(51) Int. Cl. H04B 1/707

(52) U.S. Cl. 375/148

(57) ABSTRACT

A received signal whose frequency band is spread in a spread spectrum system is subjected to fast Fourier transform processing to detect an interference signal, based on a result of the detection, a frequency characteristic of a frequency variable type notch filter for eliminating a narrow-band interference signal is controlled so that a narrow-band interference signal is eliminated from the received signal, whereby a spread spectrum communication system receiving device resistant to narrow-band interference can be provided by a simple configuration.

### CROSS REFERENCE TO RELATED APPLICATIONS

This application is based upon and claims the benefit of priority from the prior Japanese Patent Application No. 2003-347564, filed on Sep. 1, 2003, the entire contents of which are incorporated herein by reference.

### BACKGROUND OF THE INVENTION

1. Field of the Invention

The present invention relates to elimination of a narrow-band interference signal in a spread spectrum system communication device.

2. Description of the Related Art

In spread spectrum communication, communication is performed by spreading a transmitted signal over a much wider frequency band than a frequency band of the transmitted signal. The spread spectrum communication is, in principle, excellent in fading characteristic and capable of high-speed communication, whereby, in recent years, its application field has been expanding, including a cellular phone and a wireless LAN.

It is expected that the application field of radio communication will further expand by adopting a spread spectrum system also in radio communication equipment, which utilizes weak radio waves, while using its characteristic to the full. However, in the case of a weak radio wave which does not have a frequency band provided for a specific communication service such as a cellular phone, interference characteristics are an important problem.

In particular, in a spread spectrum system with a wide occupied bandwidth, the probability of the existence of a narrow-band or single-frequency interference radio wave within a frequency band used for communication is high, and it is necessary to eliminate the interference radio wave. Improvements in such interference characteristics are effective on the spread spectrum communication system in terms of an improvement in communication quality without being limited to the weak radio wave.

The elimination of an interference signal has been hitherto devised, and it is disclosed in Japanese Patent No. 2753565, Japanese Patent Application Laid-open No. Hei 2-182045, and so on. However, in arts described in these documents, a means for detecting the interference signal is complicated, which makes it impossible to configure a device at low cost.

### SUMMARY OF THE INVENTION

An object of the present invention is to provide a spread spectrum communication system receiving device resistant to narrow-band interference by a simple configuration.

A spread spectrum communication system receiving device of the present invention is a spread spectrum communication system receiving device for receiving a signal transmitted in a spread spectrum communication system, the receiving device comprising: an A/D converter for converting a received signal to digital data; a Fourier transformer for subjecting the received signal digitized by the A/D converter to fast Fourier transform and detecting an interference signal based on a result of the transformation; and a notch filter, whose frequency characteristic is variable, for eliminating a frequency component associated with the interference signal from the received signal based on a result of the detection in the Fourier transformer.

According to the aforementioned configuration, it is possible to subject a received signal in a spread spectrum communication to fast Fourier transform processing to detect an interference signal, and control the frequency characteristic of the notch filter based on a result of the detection to eliminate a narrow-band interference signal from the received signal. Accordingly, single-frequency and narrow-band noise in the received signal can be eliminated by a simple configuration, whereby a spread spectrum communication system receiving device having improved communication quality of spread spectrum communication and resistant to narrow-band interference can be provided.

Moreover, when the aforementioned notch filter is composed of a digital filter, all of circuits associated with the detection and elimination of the interference signal can be digitized, which enables the IC implementation of the device.

### BRIEF DESCRIPTION OF THE DRAWINGS

FIG. 1 is a block diagram showing an example of the configuration of a spread spectrum system communication device according to an embodiment of the present invention;

FIG. 2 is a diagram showing an example of the spectrum of a spread signal and an interference signal;

FIG. 3 is a diagram showing the spectrum of the spread signal and interference signal frequency-converted to baseband;

FIG. 4 is a block diagram showing an example of the configuration of the spread spectrum system communication device in this embodiment in which a digital filter is adopted.

### DETAILED DESCRIPTION OF THE PREFERRED EMBODIMENTS

Hereinafter, an embodiment of the present invention will be described based on the drawings.

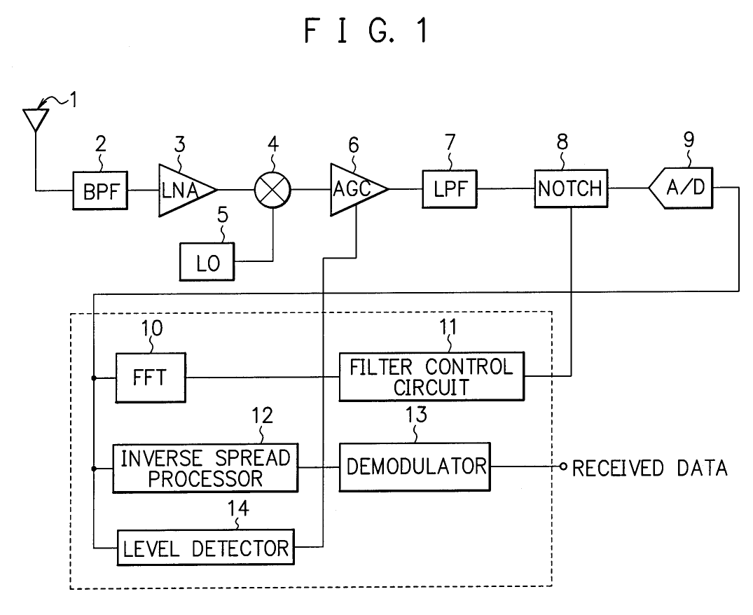

FIG. 1 is a block diagram showing an example of the configuration of a spread spectrum system communication device, and more specifically, receiving device according to the embodiment of the present invention.

A high-frequency received signal received by an antenna 1 in the spread spectrum system receiving device shown in FIG. 1 is inputted from the antenna 1 to a band-pass filter (BPF) 2, and its unnecessary frequency band is eliminated by the band-pass filter 2. Thereafter, the high-frequency received signal is amplified by a low-noise amplifier (LNA) 3.

A mixer 4 performs frequency conversion by mixing the high-frequency received signal amplified by the low-noise amplifier 3 with an output from a local oscillator (LO) 5. In this embodiment, a direct conversion system is shown as an example. Hence, an output frequency (frequency of an output signal) of the local oscillator 5 is equal to a received frequency, and the high-frequency received signal is directly converted to a baseband signal by the mixer 4.

The baseband signal obtained by the conversion by the mixer 4 is amplified by a variable gain amplifier (AGC) 6, and its unnecessary high-frequency component (or components) is (or are) eliminated by a low-pass filter (LPF) 7. The received signal (baseband signal) processed by the low-pass filter 7 is inputted to a notch filter (NOTCH) 8, where a narrow-band interference signal is eliminated. The received signal processed in the notch filter 8 is inputted to an analog-digital converter (A/D converter) 9 and converted to digital data.

The received signal converted to the digital data by the A/D converter 9 is supplied to a fast Fourier transform (FFT) processor 10, and an interference signal is detected by fast Fourier conversion processing in the FFT processor 10. A filter control circuit 11 controls the notch filter 8 according to a result of the detection of the interference signal by the FFT processor 10 and changes the frequency characteristic of the notch filter 8.

More specifically, in this embodiment, by subjecting the received signal to the FFT processing in the FFT processor 10, the received signal is transformed from time-axis digital data into frequency-axis digital data to detect the interference signal. According to the detection result of the interference signal, the filter control circuit 11 controls the notch filter 8 in such a manner that the frequency characteristic of the notch filter 8 is adapted to the frequency of the interference signal to thereby eliminate the interference signal from the received signal.

The received signal converted to the digital data by the A/D converter 9 is supplied to an inverse spread processor 12, subjected to inverse spread processing in the inverse spread processor 12, and thereafter demodulated in a demodulator 13. Thus, the interference signal is eliminated from the high-frequency received signal received by the antenna 1, and then the high frequency received signal is subjected to the inverse spread processing and the demodulation processing to obtain receive data.

A level detector 14 here is for controlling the gain of the variable gain amplifier 6 according to the signal level of the received signal.

Note that the processing in each of the FFT processor 10, the filter control circuit 11, the inverse spread processor 12, the demodulator 13, and the level detector 14 which are provided at a stage subsequent to the A/D converter 9 is digital processing. In other words, the FFT processor 10, the filter control circuit 11, the inverse spread processor 12, the demodulator 13, and the level detector 14 which are enclosed by a dotted line in FIG. 1 are each composed of a digital circuit (for example, a CPU, a DSP (digital signal processor), or any other digital arithmetic circuit).

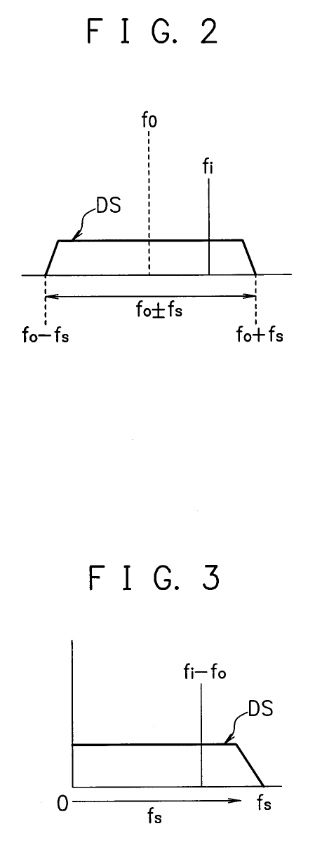

Next, the operation of detection and elimination of an interference signal by the spread spectrum system receiving device in this embodiment will be explained in detail with reference to FIG. 2 and FIG. 3. It should be mentioned that the gain control of the variable gain amplifier 6 is a basic operation of a demodulation circuit and is not a main element of the present invention, so that the explanation thereof is omitted. Note that in FIG. 2 and FIG. 3 hereinafter explained, the horizontal axis is frequency and the vertical axis is energy.

FIG. 2 is a diagram showing an example of the spectrum of the received signal. As shown in FIG. 2, an interference signal of a single frequency fi is superimposed in a situation where the spectrum is spread over a frequency band of ±fs with a frequency fo as a center, that is, within a frequency band from (fo−fs) to (fo+fs).

FIG. 3 shows a state in which this received signal is frequency-converted to a baseband signal by the mixer 4 in the aforementioned example of direct conversion. More specifically, a signal which was spread (spread signal) DS has a band from a frequency 0 Hz to a spread frequency fs, and the interference signal is frequency-converted to

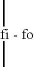

The fast Fourier transform processing (FFT processing) of the digital data obtained by conversion in the A/D converter 9 shown in FIG. 1 in the FFT processor 10 means finding the spectrum shown in FIG. 3 by a digital operation. It is easy to read the presence or absence of the interference signal and its frequency from the spectrum shown in FIG. 3, whereby the interference signal contained in the received signal can be easily detected.

In this embodiment, the frequency characteristic of the notch filter 8 is set so as to eliminate the signal of the frequency, 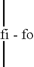
but, for example, even when plural interference signals exist, a method of selecting a maximum level interference signal, a method of selecting a center frequency so that many interference signals are within an elimination band of the filter 8, and the like are also possible.

Moreover, in this embodiment, the notch filter 8 is set at baseband, but the notch filter 8 may be set at an intermediate frequency band in a superheterodyne system.

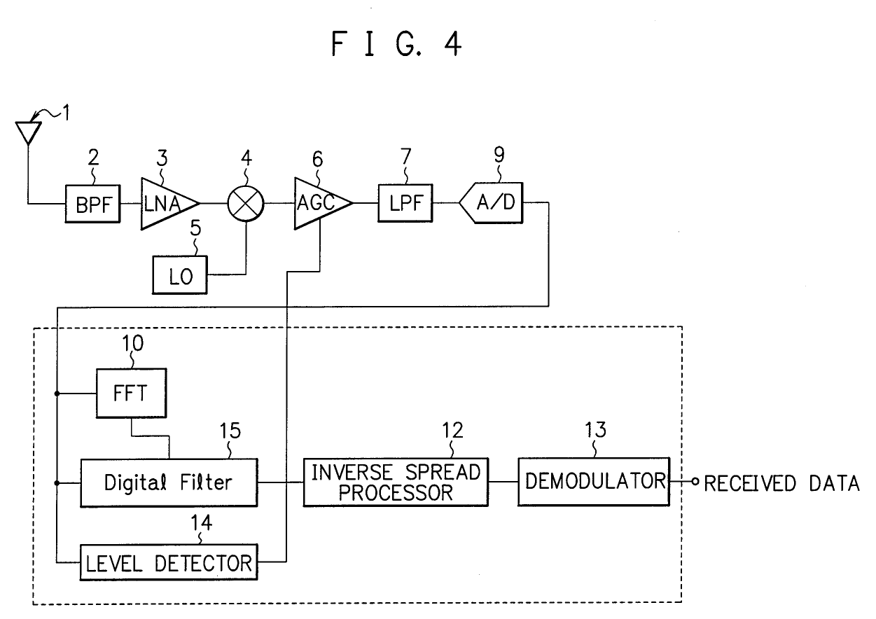

Further, FIG. 4 shows an example in which the notch filter 8 is composed of a digital filter. In a spread spectrum system receiving device shown in FIG. 4, an output of the low-pass filter 7 is inputted to the A/D converter 9, and an output of the A/D converter 9 is inputted to the FFT processor 10, a digital filter (notch filter) 15, and the level detector 14.

The digital filter 15 is, for example, composed of a CPU, a DSP, or any other digital arithmetic circuit, and its frequency characteristic is determined by a digital operation, whereby there is neither limitation nor variation according to the performance of each circuit element, which makes it possible to realize an ideal filter. Each of circuits is composed of a digital circuit although its circuit configuration becomes complicated, whereby IC implementation is easy, and a reduction in costs can be realized because of the manufacturing economies of scale and the like.

In the spread spectrum communication, with an increase in spread rate, the elimination rate with respect to single-frequency interference rises, which, however, causes an increase in occupied bandwidth at the same time. When radio communication is performed by weak radio waves, it is assumed as a precondition that single-frequency and narrow-band interference waves (interference signals) such as radio waves emitted from other communication equipment and radiation noise from electronic equipment exist, and hence there is a possibility that the increase in occupied bandwidth causes an increased influence of the aforementioned noise.

Therefore, according to the aforementioned embodiment, single-frequency and narrow-band noise in the spread spectrum communication can be eliminated, which makes it possible to improve the communication quality of the spread spectrum communication by weak radio waves, thereby leading to an increase in the utilization range of radio communication.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

1. A spread spectrum communication system receiving device for receiving a signal transmitted in a spread spectrum communication system, said receiving device, comprising:
an A/D converter for converting a received signal to digital data;
a Fourier transformer for subjecting the received signal digitized by said A/D converter to fast Fourier transform and detecting an interference signal based on a result of the transformation; and
a notch filter, whose frequency characteristic is variable, for eliminating a frequency component associated with the interference signal from the received signal based on a result of the detection in said Fourier transformer.

2. The receiving device according to claim 1, wherein said notch filter is provided at a stage previous to said A/D converter and supplies the received signal from which the frequency component associated with the interference signal is eliminated to said A/D converter.

3. The receiving device according to claim 2, further comprising a filer control circuit for controlling said notch filter in such a manner that a frequency characteristic of said notch filter is adapted to a frequency of the interference signal based on the detection result in said Fourier transformer.

4. The receiving device according to claim 1, wherein said notch filter is a digital filter provided at a stage subsequent to said A/D converter.

5. The receiving device according to claim 4, wherein said notch filter is composed of a CPU or a DSP.

6. A receiving device, comprising:
a frequency variable type notch filter for eliminating a narrow-band interference frequency component in a spread spectrum communication system from a received signal;
an A/D converter for frequency-converting the received signal to baseband and thereafter converting the frequency-converted received signal to digital data; and
a Fourier transformer for subjecting the received signal digitized by said A/D converter to fast Fourier transform and detecting an interference signal from the result of the fast Fourier transform, wherein
a frequency characteristic of said notch filter is adapted to a frequency of the interference signal to eliminate a frequency component associated with the interference signal.

7. The receiving device according to claim 6, wherein said Fourier transformer is composed of a CPU or a DSP.

8. The receiving device according to claim 6, wherein said notch filter is a digital filter, determines a filter characteristic capable of eliminating the frequency component of the interference signal detected from the result of the fast Fourier transform, and changes a constant of the digital filter.

9. The receiving device according to claim 8, wherein said notch filter is composed of a CPU or a DSP.
